(19) United States
(12) Patent Application Publication
(10) Pub. No.: US 2015/0177715 A1
(43) Pub. Date: Jun. 25, 2015

(54) WIRELESS UNIVERSAL INTERFACE DEVICE FOR THEATRICAL EFFECTS

(71) Applicant: James David Smith, Raleigh, CA (US)

(72) Inventor: James David Smith, Raleigh, CA (US)

(21) Appl. No.: 14/134,515

(22) Filed: Dec. 19, 2013

(51) Int. Cl. G05B 15/02; H04W 88/02

(52) U.S. Cl. CPC G05B 15/02; H04W 88/02

(57) ABSTRACT

Provided is a system for controlling theatrical effects. The system comprises a main console and one or more battery-powered wireless controller devices. The console can transmit DMX data wirelessly to the wireless controller devices. The controller devices convert DMX data into different formats using a protocol converter. The converted data can be made available to external devices via different hardware ports and outputs. Another controller device can control an H-bridge powered dimmer. The H-bridge can be selected to operate either as an AC inverter or a bidirectional DC motor driver. User-adjustable parameters may be available to select the functional mode and characteristics of operation in each mode.

### CROSS REFERENCE TO RELATED APPLICATIONS

The present application claims priority benefit of the U.S. provisional application No. 61/823,201, filed on May 14, 2013 and the U.S. provisional application No. 61/825,662, filed on May 21, 2013. The subject matter of aforementioned applications is incorporated herein by reference for all purposes to the extent that such subject matter is not inconsistent herewith or limiting hereof.

### TECHNICAL FIELD

This disclosure relates generally to devices for controlling theatrical effects, and more specifically to portable radio-controlled devices using the Digital MultipleX (DMX) protocol for controlling theatrical effects in theatrical and film sets, set pieces, props, practicals, and other entertainment and educational applications

### BACKGROUND

The devices for controlling theatrical effects are widely used in entertainment business. Generally, a system for creating theatrical effects comprises several controller devices governing different motor engines, lamps, devices for generating lights, sound, fogs and other effects. The controller devices, in turn, are controlled by a central console using the industry-standard Digital MultipleX (DMX) protocol by means of standard DMX cables. There are also controller devices which are able to receive DMX signals via a radio network.

Propsmasters and costume designers are often called upon to incorporate various small electronic devices into their work, some of the devices are commonly available and others are custom built. For example, a show designer might demand smoke from a doll-house chimney; a costume may need to light up with LEDs executing complex chase patterns; a chair may need to collapse on demand using a hobby servo motor to pull a cable release pin.

Most commercial productions use DMX data for control of lighting and other effects. In addition, the wireless DMX has become somewhat commonplace. But in many cases, DMX data is not ideal for use inside props and costumes.

Therefore, there is a need for a data receiver that can output data formats useful to props makers and costumers and provide a means for the end users to tune data formats and ranges for suitability in their application.

### SUMMARY

Embodiments of the present disclosure may address limitations present in the systems for delivering data to stage special effects devices described above.

In some embodiments, a system for generating lighting effects may comprise one or more portable, battery-powered, radio-controlled wireless controller devices small enough to easily hide in most theatrical and film sets, set pieces, props, and practicals. Several such wireless controller devices may be controlled by a single wireless controller.

In some embodiments, the controller device may comprise a sophisticated data converter that may allow a user to define the way “raw” DMX channel data will be rendered in various other formats to control a range of physical devices demanding a variety of different control methods.

In certain embodiments, the controller device may incorporate a full H-bridge power driver controlled by firmware in a microcontroller. The firmware may allow the H-bridge to be used as a solid-state bidirectional DC motor driver or as an inverter to produce AC waves.

Numerous user-adjustable parameters may be available to select the functional mode, and characteristics of operation in each mode. In addition, many parameters can be controlled with incoming wireless DMX data, for real-time remote control. To ensure appropriate range and influence, incoming DMX data can be scaled, inverted, and shifted before being applied to any particular parameter.

### BRIEF DESCRIPTION OF DRAWINGS

Embodiments are illustrated by way of example and not limitation in the figures of the accompanying drawings, in which like references indicate similar elements and in which:

FIG. 1 shows an example system for controlling theatrical effects.

FIG. 2 depicts a battery-powered radio-controlled device for controlling theatrical effects according to an example embodiment.

FIG. 3 depicts a battery-powered radio-controlled device for controlling theatrical effects according to another example embodiment.

FIG. 4 is a flow chart diagram showing an example method for controlling theatrical effects disposing a battery-powered radio-controlled device.

FIG. 5 depicts a battery-powered radio-controlled device with an integrated H-bridge power dimmer for controlling theatrical effects.

FIG. 6 is a flow chart diagram showing an example method for controlling theatrical effects disposing a battery-powered radio-controlled device with integrated H-bridge power dimmer.

### DETAILED DESCRIPTION

The following detailed description includes references to the accompanying drawings, which form a part of the detailed description. The drawings show illustrations in accordance with example embodiments.

The systems, devices and methods described herein allow for controlling theatrical effects engines and devices. The technology for controlling described in current disclosure may be practiced in theatrical and film sets, set pieces, props, practicals, and other entertainment and educational applications.

In some embodiments, the system for controlling theatrical effects may comprise a main console device and a set of battery-powered wireless controller devices. In some embodiments the controller device may comprise a receiver, a protocol converter and set of hardware ports and outputs. The receiver can be configured to receive a data in a proprietary format, convert the received data to DMX data, and provide the DMX data to a protocol converter. The protocol converter may be configured to either emulate a memory peripheral to be read via hardware ports or provide data to outputs in different formats. In other embodiments, the controller device may comprise a microcontroller and integrated H-bridge power dimmer. The H-bridge power dimmer may be configured to operate as an AC inverter or a bidirectional DC motor driver.

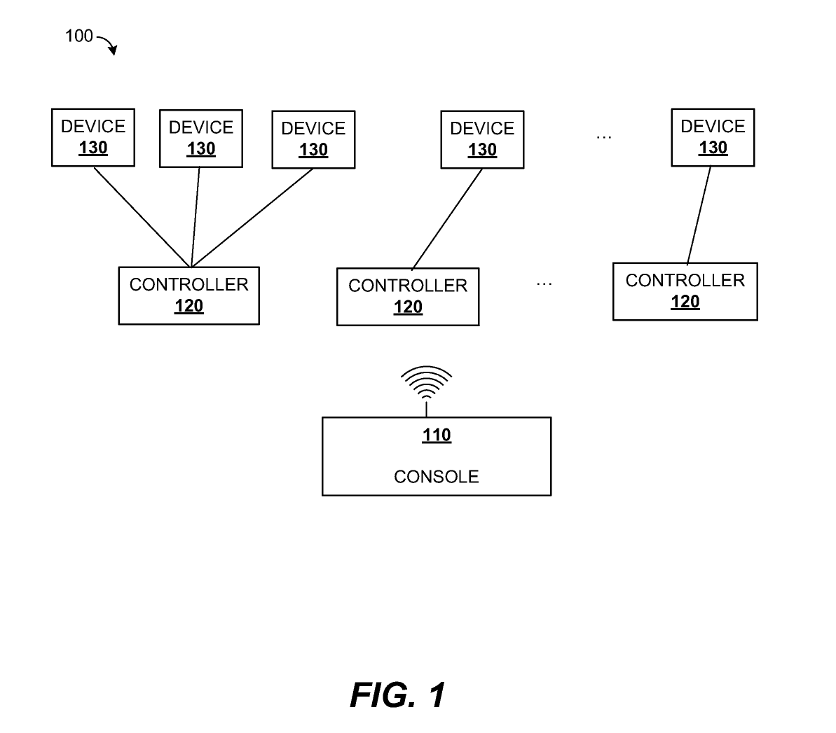

FIG. 1 shows a system 100 for controlling theatrical effects according to an example embodiment. The system 100 may comprise a console unit 110 and one or more battery-powered radio-controlled devices 120. The controller devices 120 may be placed on a theatrical or film stage, or another entertainment set, and controlled by the console unit 110 via a radio signal. Each of the controller devices, may, in turn, govern one or more theatrical effect devices 130.

In some embodiments the console unit 110 may transmit Digital MultipleX (DMX) data directly to controller devices 120. In other embodiments the console unit 110 may convert the DMX data into a proprietary wireless format and transmit the data in proprietary format to controller devices 120 by a radio signal. The proprietary format may use System IDs for privacy and may include error checking and other defenses against dropouts and interference.

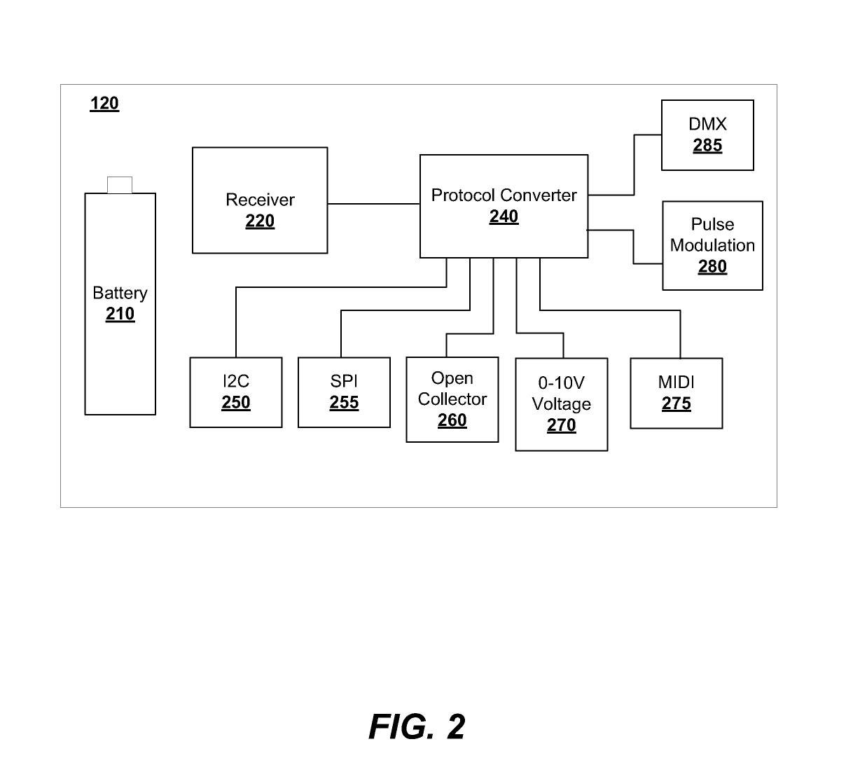

FIG. 2 depicts a battery-powered radio-controlled device 120 for controlling theatrical effects according to an example embodiment. The controller device 120 may include at least a battery 210, a receiver unit 220, a protocol converter unit 240, and one or more hardware ports and outputs. Each of the hardware ports and outputs may comprise one of the following:

an Inter-Integrated Circuit (I²C) port;

a Serial Peripheral Interface (SPI) port;

an Open-Collector output;

an 0-10V Control-Voltage output;

a Pulse Modulation output;

a Musical Instrument Digital Interface (MIDI) data output; and

a DMX data output.

Multiple devices 130 connected to hardware ports and outputs can be controlled simultaneously, responding to data from the same wireless DMX console 110. By configuring data ports on each device to respond to different DMX channels, a range of different props and effects can all be controlled from one main DMX console 110 that runs the entire show.

In some embodiments of controller devices 120, the I²C port and the SPI port may share the same data connection points, while in other embodiments the I²C port and the SPI port may have different connection points, so the ports may be used independently and simultaneously.

Similarly, in some embodiments, the MIDI data output and the DMX data output can share data connection points, while in other embodiments the MIDI data output and DMX data output may have different connection points, so that the ports may be used independently and simultaneously.

The receiver 220 may receive data in a proprietary wireless format transmitted by the controller 110 of FIG. 1, convert the data to the industry-standard DMX format and pass the converted data to protocol converter 240. In certain embodiments the receiver 220 may receive data in a proprietary wireless format and pass the received data to protocol converter 240 without converting the received data to DMX format.

In the embodiments of device 120, comprising at least one of the I²C ports or the SPI ports, the protocol converter 240 may be configured to emulate a memory peripheral with 512 memory addresses representing the 512 channels of DMX universe. One or more external microprocessor-based devices having an I²C or an SPI communication bus may have access to the emulated memory peripheral via the I²C or SPI interface ports of device 120 to query any DMX channel provided to protocol converter in real time. The external devices may dispose one of the Arduino, Raspberry Pi, PicAxe, Basic Stamp and other microprocessors, microcontroller, and system-on-chip devices.

In the embodiments of device 120 comprising one or more open collector outputs, the protocol converter may be configured to assign a DMX channel to any of available open collectors. Normal or inverted polarity of the open collector may be selected by a user using console 110. A DMX level may be set as a turn-on threshold for the open collector.

In some embodiments, the open collector may be configured as Pulse-Width-Modulation dimmer to dim small lamp or light-emitting diode (LED) or to control the speed of small DC motor.

In the embodiments of device 120 comprising one or more 0-10V Control-Voltage (CV) outputs, the protocol converter 240 may be configured to assign a DMX channel to any available CV outputs by a user via console 110. The protocol converter 240 may be configured to scale, shift, and invert the DMX data, and to assign linear or inverse-square-law output curves.

In the embodiments of device 120 comprising one or more Pulse Modulation (PM) outputs, the protocol converter 240 may be configured to assign a DMX channel to any available PM outputs by a user via console 110. The protocol converter 240 may be configured to scale, shift, and invert the DMX data to control the direction and range of motion of connected device, i.e. a servo motor.

In the embodiments of device 120 comprising one or more MIDI data outputs, the protocol converter 240 may be configured to convert 16 DMX channels to a MIDI note messages. The starting DMX channel, MIDI channel, and MIDI starting note number may be selected by a user using console 110. Modes for using MIDI note velocity and MIDI polyphonic aftertouch for DMX channel levels may be also selected by a user using console 110.

In another embodiment, any number of DMX channels could be processed, and DMX data could be mapped to any desired MIDI channel and parameter. In yet another embodiment, the user could build specific MIDI messages to be sent when particular DMX data events occur.

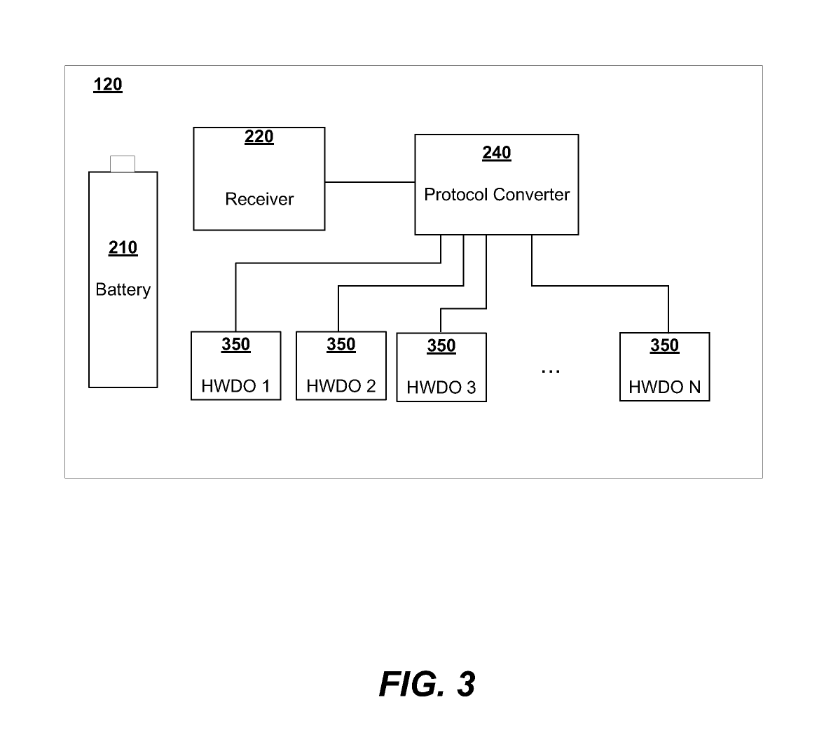

FIG. 3 depicts a battery-powered radio-controlled device 120 for controlling theatrical effects according to another example embodiment. The controller device 120 may include at least a battery 210, a receiver unit 220, a protocol converter unit 240, and one or more hardware data outputs (HWDO) 350.

The format of data outputted by the HWDO may be selected using one or more DMX channels. The selectable formats include but not limited to: DMX, DIMI, Pulse Code/PWM, Open Collector, SPI, and I²C.

Some embodiments of the controller device 120 may include both format selectable hardware data outputs and output ports configured to output data in only one pre-fixed format. In certain embodiments, certain DMX channels received by the controller device 120 may be reserved for fixed data format. For example, in some embodiments DMX channel 194 and DMX channel 250 can be reserved for the PWM data format. Some of data formats can be specified using more than one DMX channels. For example in case of the MIDI format, several DMX channels can be used to specify how DMX data will be converted to a specific MIDI protocol.

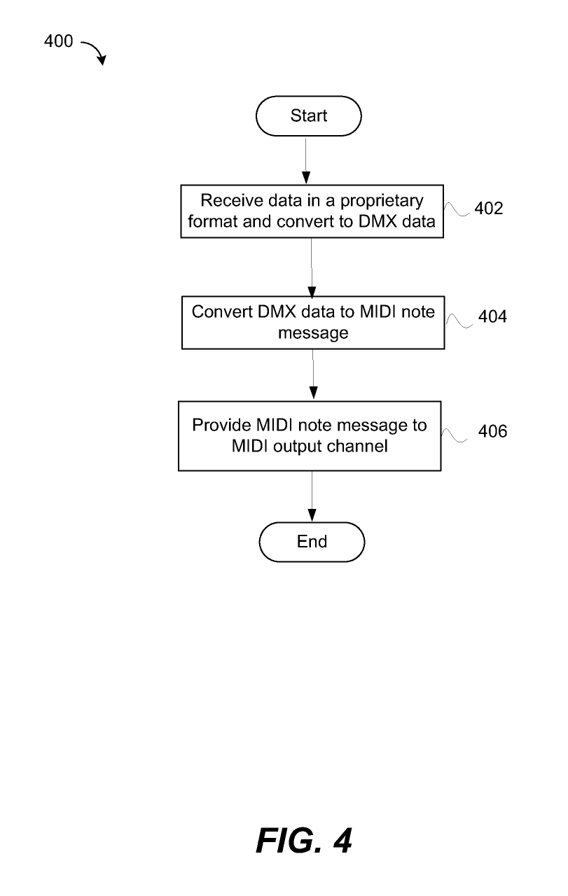

FIG. 4 shows a flow chart diagram showing method 400 for controlling theatrical effects using device 120 comprising one MIDI output channel. The example method 400 of FIG. 4 may also include additional or fewer steps than those illustrated.

In step 402, data in proprietary code may be received by receiver 220 from controller 110 via radio signal. The data may be further converted from a proprietary format to the industry-standard DMX format and passed to protocol converter 240.

In step 404, the protocol converter 240 may convert data of the 16 predetermined DMX channels to a MIDI note message using additional information provided in other preselected DMX channels. In step 406, the MIDI note message generated protocol converter 240 may be provided to MIDI output.

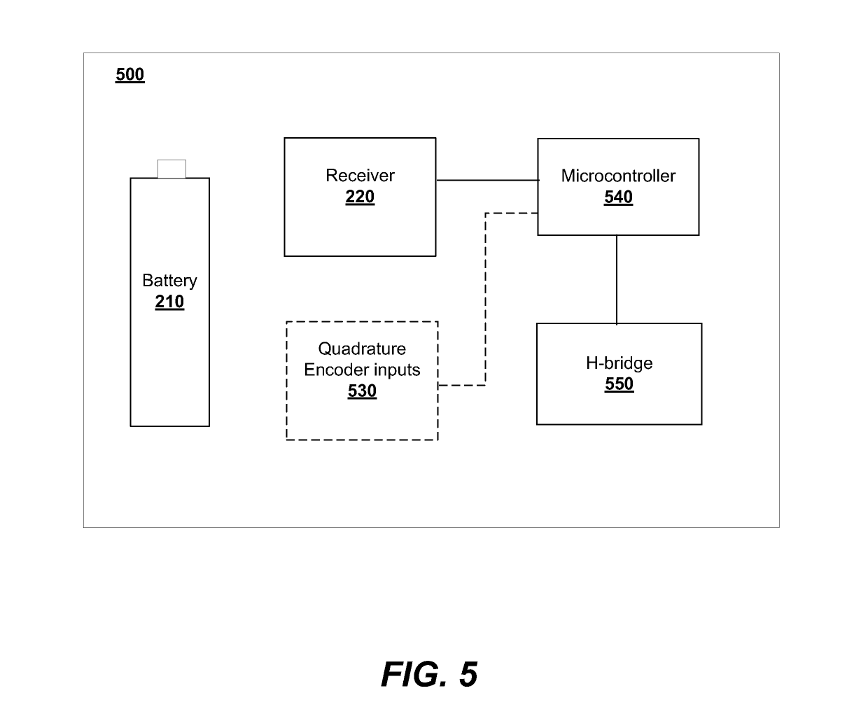

FIG. 5 shows another example embodiment of a battery-powered radio-controlled device 500 with an integrated H-bridge power dimmer for controlling theatrical effects. The device 500 may include at least a battery 210, receiver 220, a microcontroller 540, and one or more integrated H-bridge power dimmers. In some embodiments, the device 500 of FIG. 5 may further include quadrature encoder inputs 530. The receiver 220 is substantially identical to the receiver described above in connection with FIG. 2. The microcontroller 540 may include a firmware and a storage memory. The microcontroller 540 may be configured to receive DMX data from receiver 220 and control the H-bridge power dimmer 550.

The DMX data may provide, to a microcontroller, a selection of functional mode of H-bridge power dimmer 550 and parameters of operations associated with selected mode. The functional modes include, but not limited to bidirectional control of DC motors, DC motor speed control, DC motor servo positioning, telephone bell ringing, dimming of electroluminescent (EL) materials, and speed control of AC motors. In some embodiments, several DMX channels may be reserved for parameters controlled in real time by user via wireless console 110. To ensure appropriate range and influence, incoming DMX data can be scaled, inverted, and shifted before being applied to any particular parameter. The same DMX channel can simultaneously influence multiple parameters, each with independent scaling.

In some embodiments, the H-bridge power dimmer 550 may be configured to operate as an inverter to produce AC waves. The microcontroller 540 may be configured to control the frequency, amplitude, and shape of the AC wave. In some example embodiments, the microcontroller 540 may set the H-bridge power dimmer 550 to generate an AC waves with high frequency (i.e. 300 Hz) and amplitude of the AC waves being controlled using assigned DMX channel by a user via wireless console 110. The resulting AC wave may be used for generating a dimming electroluminescent (EL) wire.

In other example embodiments, the microcontroller 540 may set the H-bridge power dimmer 550 to generate sine AC waves with a frequency being controlled using an assigned DMX channel by a user via wireless console 110. The output can be used to control the speed of a synchronous AC motor in, for example, an electric clock or fan.

In yet another example of embodiments, the microprocessor 540 may set the H-bridge power dimmer to generate a 20 Hz sine wave. One DMX channel may be assigned to control the amplitude of this wave by a user via console 110, with a non-dim (switching) response. The output may be used for ringing a telephone bell. The ring pattern may be also controlled directly from a DMX console 110.

In other set of embodiments the H-bridge power dimmer 550 may be configured to operate as bidirectional DC motor driver. For an example, the H-bridge in bidirectional DC motor driver mode may be used to control a linear actuator that opens and closes a door. In some embodiments, the quadrature encoder inputs 530 may be used to allow the H-bridge power dimmer 550 to be configured as a closed-loop servo controller.

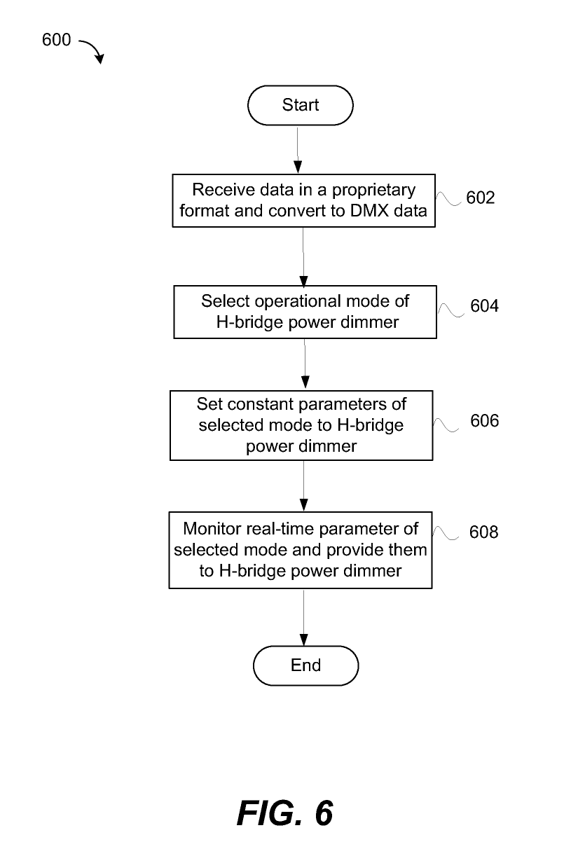

FIG. 6 shows a flow chart diagram showing method 600 for controlling theatrical effects using device 500 with integrated H-bridge powered dimmer. The example, method 600 of FIG. 6 may also include additional or fewer steps than those illustrated. In step 602, data in proprietary code may be received by receiver 220 from controller 110 via radio signal. The data may be further converted from a proprietary format to industry-standard DMX format and passed to the microcontroller 540.

In step 604, the microcontroller 540 may select the operational mode of the H-bridge power dimmer 550. In step 606, the microcontroller 540 may set the constant parameters of operational mode of the H-bridge power dimmer 550. In step 608, the microcontroller 540 may monitor real-time parameters associated with selected mode and provide the real-time parameters to the H-bridge power dimmer 550.

Thus, systems, devices and methods for controlling theatrical effects are disclosed. It should be appreciated by those skilled in art that any other communication protocols commonly used in the entertainment industry, like MIDI, or ACN (Architecture for Control Networks) protocol, and so on, can be used instead of or with the DMX protocol in embodiments of the present disclosure.

What is claimed is:

1. A battery-powered radio-controlled device for controlling theatrical effects, the device comprising:
a receiver, the receiver being configured to receive a control data via a radio network;
a protocol converter, the protocol converter being configured to receive the control data from the receiver; and
hardware outputs.

2. The device of claim 1, wherein the control data comprise one of the following: DMX data, ACN data, MIDI data or data in a communication protocol used in entertainment industry.

3. The device of claim 1, wherein at least one of the hardware outputs includes Inter-Integrated Circuit (I²C) port and wherein the protocol converter is configured to emulate the control data as a memory peripheral having 512 addresses.

4. The device of claim 1, wherein at least one of hardware outputs includes a Serial Peripheral Interface (SPI) output port and the protocol converter is configured to emulate the control data as a memory peripheral having 512 addresses.

5. The device of claim 1, wherein one of the hardware outputs is an open collector and the protocol converter is configured to:
convert the control data to output parameters; and
provide the output parameters to the open collector.

6. The device of claim 1, wherein at least one of the hardware outputs is a 0-10V control voltage output and the protocol converter is configured to:
convert the control data to output parameters; and
provide the output parameters to the 0-10V control voltage output.

7. The device of claim 1, wherein at least one of hardware outputs is a Pulse Modulation output and the protocol converter is configured to:
convert the control data to output parameters; and
provide the output parameters to Pulse Modulation output.

8. The device of claim 1, wherein at least one of hardware outputs is a MIDI output and the protocol converter is configured to
convert the control data to a MIDI note message; and
provide the MIDI note message to the MIDI output.

9. The device of claim 1, wherein at least one of the hardware outputs is a DMX output and the protocol converter is configured to provide the control data to the DMX output.

10. The device of claim 1, wherein at least one of the hardware outputs is a dimmer output and the protocol converter is configured to set a level of the dimmer output based on the control data.

11. A system for controlling theatrical effects, the system comprising:
a console; and
at least one battery-powered radio-controlled device, the device comprising:
a receiver, the receiver being configured to receive a control data via a radio network;
a protocol converter, the protocol converter being configured to receive the control data from the receiver; and
hardware outputs.

12. The system of claim 11, wherein the console is configured to:
receive DMX, MIDI, ACN or other communications protocol commonly used in the entertainment industry;
convert the received data into control data in a proprietary format;
transmit the control data in the proprietary format via a radio network.

13. The system of claim 11, wherein at least one of hardware outputs includes I²C output port and the protocol converter is configured to emulate the control data as a memory peripheral having 512 addresses.

14. The system of claim 11, wherein at least one of hardware outputs includes a SPI output port and the protocol converter is configured to emulate the control data as a memory peripheral having 512 addresses.

15. The system of claim 11, wherein one of hardware outputs is an open-collector transistor output and the protocol converter is configured to provide parameters to the open-collector based on the control data.

16. The system of claim 11, wherein at least one of hardware outputs includes a 0-10V control voltage output and the protocol converter is configured to:
convert the control data to output parameters; and
provide output parameters current to the 0-10V control voltage output.

17. The system of claim 11, wherein at least one of hardware outputs is a Pulse Modulation output and the protocol converter is configured to:
convert the control data to output parameters; and
provide the output parameters to Pulse Modulation output.

18. The system of claim 11, wherein at least one of hardware outputs is a MIDI output and the protocol converter is configured to:
convert the control data into a MIDI note message; and
provide the MIDI note message to the MIDI output.

19. The system of claim 11, wherein at least one of the hardware outputs includes a DMX output and the protocol converter is configured to provide the control data to the DMX output.

20. The system of claim 11, wherein at least one of the hardware outputs is a dimmer output and the protocol converter is configured to set a level of the dimmer output based on the control data.

21. A method for controlling theatrical effects, the method comprising
receiving, by a console, control data, the control data comprising on of the following: DMX data, ACN data, MIDI data or data in a communication protocol used in entertainment industry;
converting, by a console, the control data to data in a proprietary format;
transmitting via radio network, by a console, the data in a proprietary format to a battery-powered radio-controlled device, the device comprising:
a receiver;
a protocol converter; and
hardware outputs wherein each of the hardware outputs being one of the following:
an I²C output port;
an SPI output port;
an open-collector transistor output;
an 0-10V control voltage output;
an Pulse Modulation output;
an MIDI output;
a dimmer output; and
a DMX output;
receiving, by the receiver, data in the proprietary format;
converting, by the receiver, the data in the proprietary format into the control data;
providing, by the receiver, the control data to the protocol converter;
generating, by the protocol converter, based on the control data, output data; and
providing the output data to the hardware outputs.
